(19) United States
(12) Patent Application Publication
(10) Pub. No.: US 2023/0266740 A1
(43) Pub. Date: Aug. 24, 2023

(54) OPTIMIZING PRINT PROCESS PARAMETERS IN 3D PRINTING

(71) Applicant: Essentium IPCO, LLC, Pflugerville, TX (US)

(72) Inventors: Chad Eichele, Lake Forest, CA (US); William Jack MacNeish, III, Santa Ana, CA (US); Iris Gisey Euan Waldestrand, Puebla (MX); Jorge Arturo Mijares Tobias, Puebla (MX); Carl Eckhardt, Austin, TX (US); Luke Johnson, Austin, TX (US)

(21) Appl. No.: 18/041,307

(22) PCT Filed: Aug. 10, 2021
(86) PCT No.: PCT/US21/45361

§ 371 Date: Feb. 10, 2023

Related U.S. Application Data
(60) Provisional application No. 63/064,193, filed on Aug. 11, 2020.

(51) Int. Cl. G05B 19/4099

(52) U.S. Cl. CPC G05B 19/4099; G05B 2219/49023

(57) ABSTRACT

A process of optimizing a 3D printing process parameters and a processor control system for executing the process including parsing computer numerical control code for printing a 3D object into a plurality of chunks, determining a process value for each of the plurality of chunks, selecting a scaling factor, and adjusting a paired process parameter in the computer numerical control code for each of the plurality of chunks based on the scaling factor.

### FIELD

The present disclosure is directed to a system for 3D printing and method for optimizing print process parameters in 3D printing.

### BACKGROUND

3D printers utilize a set of instructions, typically in the form of a computer numerical control programming language, to direct the movements of the print head when depositing filament on the print platform. While the print instructions may be manually programed, print instructions are often automatically programmed through computer aided machining (CAM) software that derives the g-code from a computer aided design (CAD) file. The CAD file representing the three-dimensional (3D) object is manipulated by the software to define the printed object scale relative to the design scale, slice the 3D object into a number of layers based on, for example, an assumed filament thickness, divide the object up into chords or segments, define infill, and determine exposed wall thicknesses. Then for each layer, a series of actions is created for moving the print head and depositing the filament. Such actions include defining a home position, starting and stopping locations, distances of travel, rates of travel, interpolation of mid-points, returns to the home position, etc. The series of actions are codified as print instructions as g-code or another form of numerical control code. These instructions are then provided to and executed by the 3D printer.

The instructions, however, may not take into account localized printing conditions that may ultimately affect part quality. For example, consider the 3D printing of a pyramid. The base of the pyramid is deposited on the printing platform. As the infill is generally printed at a lower density than the walls, the average density of the pyramid layers increases towards the apex of the pyramid and the cross-section of the pyramid decreases. This creates a situation where at the top of the pyramid, more filament material is present in a relatively smaller area, increasing thermal mass, and reducing the realized cooling rate (the actual rate at which the material cools). Ultimately, in some instances this may lead to the warpage or collapse of the pyramid near the apex as the deposited filament remains in a molten or softened state longer than the base of the pyramid.

While the methods of generating a print file work to achieve their intended purpose, there is a need for new and improved systems and processes for 3D printing.

### SUMMARY

According to several aspects, the present disclosure relates to a process of optimizing 3D printing process parameters. The process includes parsing computer numerical control code for printing a 3D object into a plurality of chunks, determining a process value for each of the plurality of chunks, selecting a scaling factor, and adjusting a paired process parameter in the computer numerical control code for each of the plurality of chunks based on the scaling factor.

In further aspects, the scaling factor is generated by comparing the process value to an ideal value to determine the scaling factor.

In further aspects, the plurality of chunks is defined by a time period, the process value is an average velocity of a print head and the ideal value is an ideal velocity of the print head.

In further aspects, the paired process parameter is a nozzle temperature.

In additional aspects, the nozzle temperature is adjusted in a previous chunk to a later chunk for which the process value is determined.

In further aspects, the paired process parameter is a feed rate of a filament.

In further aspects, the time period is defined by at least one of a specified time period and a period for printing a given layer.

In further aspects, the plurality of chunks define a geometry of the 3D object, the process value is an average velocity of a print head and the ideal value is an ideal velocity of the print head.

In additional aspects, the paired process parameter is a feed rate of a filament.

In further aspects, the plurality of chunks is defined by a number of segments and the process value is a proximity metric defined by a distance from an origin per the number of segments and the paired process parameter is adjusted based on the proximity metric.

In additional aspects, the paired process parameter is a fan power.

In additional aspects, the paired process parameter is an ideal velocity of a print head.

According to several aspects, the present disclosure relates to a system for printing a 3D object. The system includes a print head carried by an x-y carriage, including a heated nozzle and a feed motor, and a processor control system. The processor control system includes executable code to: parse computer numerical control code for printing a 3D object into a plurality of chunks wherein the 3D object is printed with the print head, determine a process value for each of the plurality of chunks, generate a scaling factor, and adjust a paired process parameter in the computer numerical control code for each of the plurality of chunks based on the scaling factor.

In further aspects, the processor control system further includes executable code to: compare the process value to an ideal value to determine the scaling factor, wherein the plurality of chunks is defined by a time period, the process value is an average velocity of the print head in a given direction and the ideal value is an ideal velocity of the print head in the given direction.

In additional aspects, the paired process parameter is a nozzle temperature of the heated nozzle.

In further aspects, the processor control system further includes executable code to: compare the process value to an ideal value to determine a deviation, wherein the plurality of chunks define a geometry of a 3D printed object, the process value is an average velocity of the print head and the ideal value is an ideal velocity of the print head.

In additional aspects, the paired process parameter is a feed motor power supplied to the feed motor.

In further aspects, the plurality of chunks is defined by a number of segments and the process value is a proximity metric defined by a displacement from an origin per the number of segments.

In further aspects, the system further comprises a fan and the paired process parameter is a fan power supplied to the fan.

In further aspects, the paired process parameter is a velocity of the print head.

### BRIEF DESCRIPTION OF DRAWINGS

The drawings described herein are for illustration purposes only and are not intended to limit the scope of the present disclosure in any way.

FIG. 1 illustrates an embodiment of a 3D printer including a print head carried by an x-y carriage, according to an exemplary embodiment of the present disclosure;

FIG. 2 illustrates an embodiment of a print head, a print platform, a cooling fan and a 3d printed object on the print platform, according to an exemplary embodiment;

FIG. 3 illustrates a system for printing a 3D object, including a 3D printer and a processor control unit for optimizing the executable code for the 3D printer, according to an exemplary embodiment;

FIG. 4 illustrates a process for optimizing the executable code for printing a 3D object;

FIG. 5 illustrates a layer of a 3D printed object, according to an exemplary embodiment.

### DETAILED DESCRIPTION

The present disclosure relates to a process of optimizing three-dimensional (3D) printing parameters and a system for 3D printing. The process and system take into account localized conditions chunked either by, e.g., time or distance, for adjusting the computer numerical control code used to control the printer while printing the 3D object.

As noted above, 3D printers utilize a set of instructions, typically in the form of a computer numerical control programming language, to direct the movements of a print head when depositing filament on the print platform. The computer numerical control code often used include g-code, however, other numerical control codes may alternatively be used. The print instructions, in the form of executable code, may be manually programed into computer aided machining (CAM) software or derived from a computer aided design (CAD) file into computer aided machining (CAM) software. In aspects, the processes are coded or embodied by one or more of a number of programming languages including, but not limited to, at least one of the following: C #, C++, Python and Java.

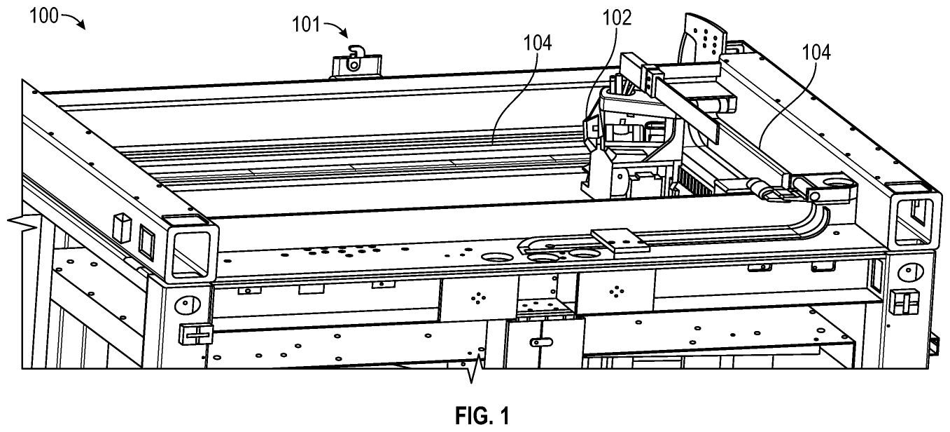

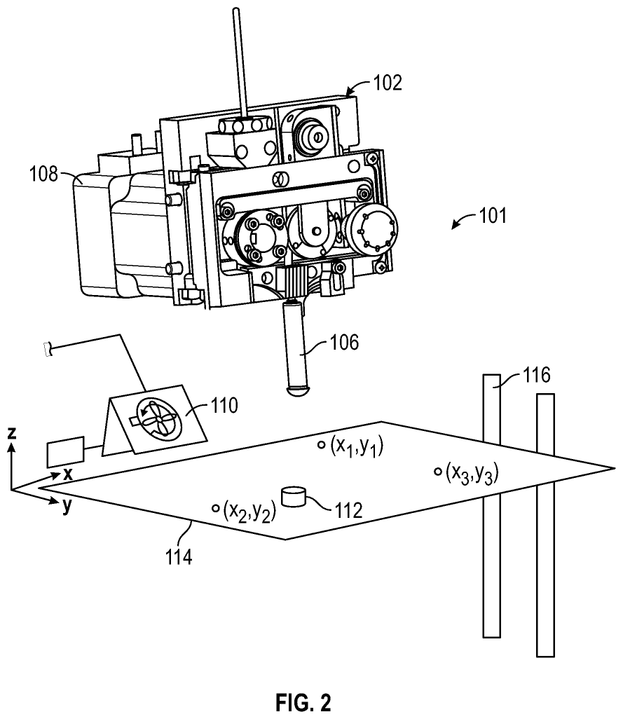

FIGS. 1 through 3 illustrate an aspect of a system 100 for printing 3D objects. The system 100 includes a 3D printer 101. The 3D printer 101 includes a print head 102 carried by an x-y carriage 104. The print head 102 includes a heated nozzle 106 and a feed motor 108. The system 100 further includes a fan 110 for cooling the heated nozzle 106 and printed 3D object 112. A print platform 114 is further provided upon which the 3D object 112 is printed. The print platform 114 is moveable in the z-direction relative to the print heat 102 to accommodate layers of extruded filament as the 3D object 112 is printed.

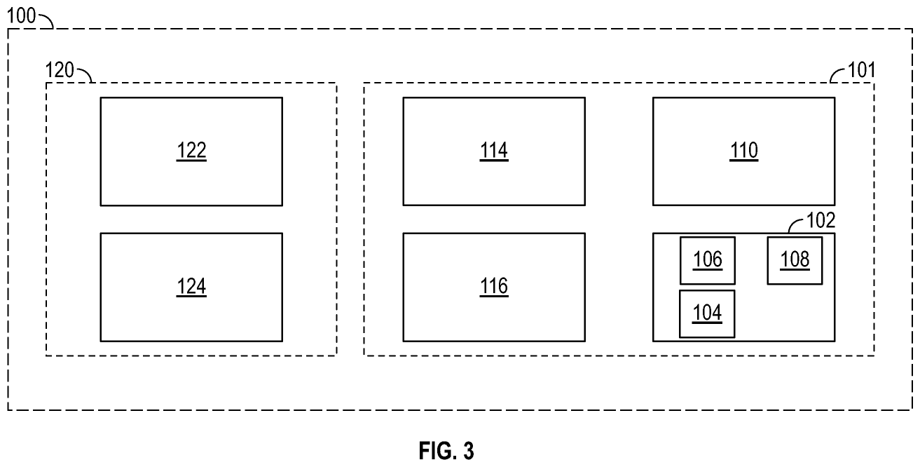

As illustrated in FIG. 3, the system 100 further includes a processor control system 120 that includes one or more processors 124, which in aspects are microprocessors. The processor control system 120 includes hardware, firmware, and software for parsing, analyzing, and modifying computer numerical control code and providing an executable code for the 3D printer 101. The processor control system 120, in aspects, resides in a computer independent of the 3D printer 101 and the output is provided to the 3D printer 101, or the processor control system 120 resides within the 3D printer 101 itself. Where more than one processor 124 is present in the processor control system 120 the processors 124 perform distributed or parallel processing protocols and the processors 124 may include, for example, application specific integrated circuits, a programmable gate array include a field programmable gate array, a graphics processing unit, a physics processing unit, digital-signal processor, or a front-end processor. The processor control system 120 is understood to be preprogrammed to execute code or instructions to perform, for example, operations, acts, tasks, functions, or steps coordinating with other devices and components to perform operations when needed.

The processor control system 120 also includes or accesses information, stored in memory 122 with which the processor 124 is operatively coupled, regarding the filament materials which may be printed with the 3D printer 101. Memory is understood as a physical device capable of storing information temporarily, such as in the case of random-access memory, or permanently, such as in the case of read-only memory. Representative physical devices include hard disk drives, solid state drives, optical discs, or storage accessible through the cloud over networks. Information stored regarding filament materials include, for example, temperature ranges and viscosity ranges at which the filament may be extruded as well as the predicted feed motor power for feeding the filament at those temperature and viscosity ranges. The relationships between temperature, viscosity, and feed rates may be predetermined and stored within the memory 122.

The processor 120 also includes or accesses information, stored in memory 122 with which the processor 120 is operatively coupled, regarding machine dynamics including, in aspects, the thermal characteristics of the heated nozzle 106, such as the rate at which the heated nozzle 106 increases in temperature upon the application of heating power or decreases in temperature upon the application of fan power.

Information stored regarding machine dynamics further includes, in aspects, the maximum rate or velocity at which the print head 102 can be moved by the x-y carriage, including maximum acceleration and maximum deceleration of the print head 102 in either the x or the y direction, and maximum velocities of the print heat 102 when performing certain functions such as making corners. Further machine dynamics information also includes, in aspects, the maximum and minimum feed motor power range, the maximum and minimum heated nozzle power range, and the maximum and minimum fan power range.

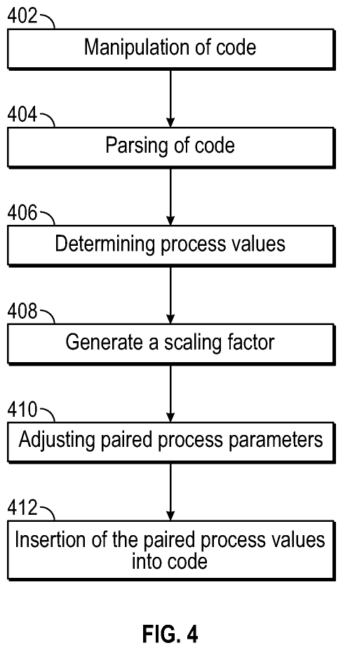

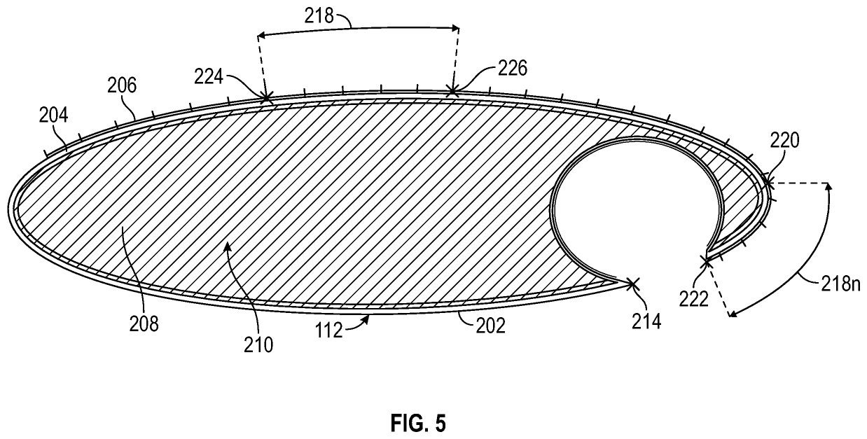

In aspects and with reference to FIG. 4, illustrating a process 400 of optimizing 3D printing process parameters, at block 402 a CAD file representing a three-dimensional (3D) object is manipulated in a slicer to define the printed 3D object scale relative to the designed 3D object scale, slices the 3D object into a number of layers based on, e.g., an assumed filament thickness, divides each layer into segments or movements, defines infill, and determines exposed wall thicknesses. FIG. 5 illustrates an example of a layer 202 of a 3D object 112 represented in CAD, in which the outer wall 204 is divided into segments 206. As may be appreciated, while only the outer wall 204 is divided into segments 206, each line of filament 208 deposited, including the infill 210, may also be divided into segments 206; however, for purposes of clarity all of the segments are not illustrated. In addition, while the segments 206 are illustrated as being relatively uniform in length, the segments 206 may alternatively be varied in length depending on various parameters such as radius of curvature. For each layer 202 and each segment 206, a series of instructions in the form of computer numerical control code is created for heating the nozzle, moving the print head, depositing the filament, and cooling. Such actions include defining a home position or a local origin 214, starting and stopping locations, distances of travel, rate of travel, interpolation of mid-points, returning to a home position, providing feed motor power, providing fan power, etc.

To take into account localized conditions prior to execution of the code by the 3D printer 101, and with reference to FIGS. 4 and 5, at block 404 the computer numerical control code is analyzed and parsed into a plurality of chunks 218, 218n within a given layer 212, a plurality of chunks 218, 218n between a number of layers 212 or a combination thereof. In aspects, the chunks 218, 218n are defined by time periods, distances traveled by the print head 102, a specific geometry that a chunk 218 defines, or a specified number of moves or segments 206. Specific geometries include corners, curves, or other arcuate geometries such as circles, ovals or ellipses, straight lines, etc. Time periods include a specified time period, such as a specified number of milliseconds, or a period for printing a given layer (accordingly, in some aspects, a chunk 218 may be the entire printed layer 202). The chunks 218, 218n are illustrated as being five segments 206 in length; however, in aspects, the chunks 218, 218n may deviate in length depending on the way that the chunks 218, 218n are parsed.

The process 400 further includes determining a process value at block 406 for each of the plurality of chunks 218, 218n and adjusting a paired process parameter included in the computer numerical control code for each of the plurality of chunks 218, 218n based on the determined process value. Process values are understood to include estimated values of process parameters such as the average velocity exhibited by the print head 102 while passing through a chunk 218, proximity metric (described further herein), print density (the average amount of filament by weight or volume), feed rate of the filament 208, or average density of a given layer 202. The process values are determined by knowns about machine dynamics and material characteristics, stored in memory 122 as discussed above. A scaling factor for each chunk 218, 218n is then selected at block 408. In aspects, the scaling factors for each process value and paired process parameter are empirically calculated and stored in memory for reference. In further aspects, the scaling factor is selected based on the calculated deviation between a process value and the ideal value, on a proximity metric, or a combination of both the calculated deviations and the proximity metric. In aspects, the scaling factors include scaling equations in which the process values are inputs in the equations and the pair parameters are outputs of the equations.

As noted, in aspects, the scaling factor is determined by comparing the process values to an ideal value to determine a deviation between the process value and ideal value. The deviation is then used to select the scaling factor, which may change depending on the process value being analyzed, for example, the scaling factor for print head velocity may be different than the scaling factors for other process values for a given chunk 218, 218n. Ideal values are understood herein as the target values or programmed values for each chunk 218, 218n and are included in the computer numerical control code at block 402. For example, in aspects, the ideal value for print head 102 velocity is the maximum velocity at which the print head 102 can travel for a particular filament material (depending on factors such as flow rate in a given temperature range, etc.). However, due to, e.g., acceleration or declaration of the print head 102 while changing direction, such as in cornering or reversing, the ideal process values may not be fully achieved in each chunk 218, 218n. Various methods of estimating the process values for a given chunk 218, 218n and their deviation from the ideal process values may be used. In aspects, known acceleration and declaration rates of the print head 102 are factored in for determining the process value for print head 102 velocity for a given chunk 218, 218n.

An example of a proximity metric is a distance from a local origin, such as (with reference to FIG. 5) the location, or starting origin 220, of the print head 102 at the beginning of a chunk 218 to the location 222 of the print head at the end of the chunk 218, divided by the number of segments of the chunk 218. Note, that the proximity metric is not necessarily the distance the print head 102 traveled. Thus, a proximity metric for a chunk 218 that defines a straight line, for example, will be different from a proximity metric for a chunk 218n that defines a curve or spiral. It should be understood that chunks 218, 2198n may exhibit other geometries, such as curves, corners, straight lines, etc. While the overall total distance traveled by the print head 102 may be the same, the location 222 of the print head 102 will be closer to the starting origin 220 in the case of the spiral than the location 226 of the print head 102 to its starting origin 224 in the case of a straight line. The proximity metric then becomes the scaling factor, or a scaling factor is chosen based on the proximity metric.

The scaling factor is used at block 410 to adjust a paired process parameter, and the scaling factor may change for each paired process parameter depending on, e.g., how much the paired process parameter is affected by the process value. Paired process parameters are understood as process parameters for the given chunk 218, 218n that are affected by the deviation in the process values from the ideal values or affected by the proximity parameter. For example, a deviation in print head 102 velocity (the process value) from the ideal print head velocity (the ideal value) will affect nozzle temperature and, potentially, feed rate or power to the feed motor 108. Accordingly, examples of process values and paired process parameters include, but are not limited to, print head velocity and filament feed rate, print head velocity and nozzle temperature, proximity metric and print head velocity, proximity metric and fan power, proximity metric and extrusion rate, etc. Accordingly, it should be appreciated that the scaling factor for each process value and paired process parameter may be different; i.e., the scaling factor for print head velocity and filament feed rate may be different from the scaling factor for print head velocity and nozzle temperature.

It is also noted that the proximity metric may be used to adjust ideal process values. For example, in aspects where the proximity metric indicates that the print head 102 will be depositing filament at relatively higher print densities for one or more chunks 218, 218n, in a layer the proximity metric is used as or used to select the scaling factor to reduce the ideal value of the print head 102 velocity, which allows more time for the filament to cool before depositing the next layer of filament.

In aspects, a plurality of chunks 218, 218n is defined by a time period, the process value is an average velocity of a print head 102 and the ideal value is maximum velocity of the print head and the paired process parameter is at least one of a nozzle temperature and filament feed rate. In another aspect, the plurality of chunks 218, 218n defines a geometry such as a corner of the 3D object, the process parameter is an average velocity of a print head 102, the ideal value is an ideal velocity of the print head and the paired process parameter is an extrusion rate of a filament. In further aspects, the plurality of chunks 218, 218n is defined by a number of segments and the process value is a proximity metric and the paired process parameter is at least one of fan power and ideal velocity of a print head.

The paired process parameters are then adjusted at block 412 in the computer numerical control code by the processor control system 120 for each of the plurality of chunks 218, 218n. In some aspects, such as in the case of the heater nozzle 106 where it takes time for the nozzle 106 to heat or cool, or in the case of feeding of filament into a filament buffer (not illustrated) before the filament is fed into the nozzle 106, the paired process parameter is adjusted in a previous chunk 218 prior (including one or more chunks prior) to a later chunk 218n where the adjustment is needed so as to pre-compensate and provide sufficient time for the nozzle temperature to change or the volume of filament in the buffer to stabilize upon reaching the chunk 218n for which the paired process parameter was calculated. The number of prior chunk(s) 218 to the chunk 218n where adjustment is needed changes dynamically based on the amount of pre-compensation being applied. For example, a temperature change of 10 degrees may require an adjustment in temperature 4 seconds beforehand, and the correlating number or chunks 218 beforehand (depending on how the chunks 218 are segmented), to reach the desired temperature at the chunk 218n in which the change is desired, where as a temperature change of 20 degrees may require an adjustment in temperature 8 seconds beforehand, and the correlating number or chunks 218 beforehand (depending on how the chunks 218 are segmented), to reach the desired temperature at the chunk 218n at which the change is desired. It should be appreciated that this “pre-compensation” allows the system to avoid being reactive, which could potentially lead to chunks 218, 218n of un-optimized printing when the parameter being changed cannot be changed instantaneously.

It should be appreciated that the magnitude and direction of the scaling factors are predetermined by modelling or experimentation for each given process value and pair process parameter. In addition, while the above describes the alteration of one or more process parameters based on a single process value, also provided is the situation where multiple process values may be used to adjust one or more process parameters. Multiple scaling factors may be determined and then weighted before applying a weighted scaling factor to one or more process parameters.

According to several aspects, and with reference again to FIGS. 1 through 3, the present disclosure relates to a system for printing a 3D object. The system 100 includes a print head 102 carried by an x-y carriage 104, including a heated nozzle 106 and a feed motor 108 and a processor control system 120. The processor control system 120 includes executable code to parse computer numerical control code for printing layers 212 of a 3D object 112 into a plurality of chunks 218, 218n, wherein the 3D object 112 is printed with the print head 102. The executable code also determines a process value for each of the plurality of chunks 218, 218n and adjusts a paired process parameter in the computer numerical control code for each of the plurality of chunks 218, 218n, based on the determined process value.

In further aspects, the processor control system 120 includes executable code to compare the process value to an ideal value to determine a deviation. In aspects, the plurality of chunks is defined by a time period. In additional aspects, the process value is an average velocity of the print head in a given direction and the ideal value is an ideal velocity of the print head in the given direction and the paired process parameter is at least one of a nozzle temperature of the heated nozzle. In additional aspects, the plurality of chunks define a geometry, such as a corner of a 3D printed object, the process parameter is an average velocity of the print head and the ideal value is an ideal velocity of the print head and the paired process parameter is an feed motor power supplied to the feed motor.

In yet further aspects, the plurality of chunks is defined by a number of segments. The process value is a proximity metric defined by a displacement from an origin per the number of segments. In further aspects, the system includes a fan and the paired process parameter is a fan power supplied to the fan. Additionally, or alternatively, the paired process parameter is a velocity of the print head.

The process and system of the present disclosure offer several advantages, these advantages include automated adjustments in the executable code based on local printing conditions, not just at the layer changes. These advantages further include improvement in part quality, including improvements in part integrity.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A process of optimizing 3D printing process parameters, comprising:
parsing computer numerical control code for printing a 3D object into a plurality of chunks;
determining a process value for each of the plurality of chunks;
selecting a scaling factor; and
adjusting a paired process parameter in the computer numerical control code for each of the plurality of chunks based on the scaling factor.

2. The process of claim 1 further comprising, wherein the scaling factor is selected by comparing the process value to an ideal value to determine the scaling factor.

3. The process of claim 2, wherein the plurality of chunks is defined by a time period, the process value is an average velocity of a print head and the ideal value is an ideal velocity of the print head.

4. The process of claim 3, wherein the paired process parameter is a nozzle temperature.

5. The process of claim 4, wherein the nozzle temperature is adjusted in a previous chunk to a later chunk for which the process value is determined.

6. The process of claim 3, wherein the paired process parameter is a feed rate of a filament.

7. The process of claim 3, wherein the time period is defined by at least one of a specified time period and a period for printing a given layer.

8. The process of claim 2, wherein the plurality of chunks define a geometry of the 3D object, the process value is an average velocity of a print head and the ideal value is an ideal velocity of the print head.

9. The process of claim 8, wherein the paired process parameter is a feed rate of a filament.

10. The process of claim 1, wherein the plurality of chunks is defined by a number of segments and the process value is a proximity metric defined by a distance from an origin per the number of segments and the paired process parameter is adjusted based on the proximity metric.

11. The process of claim 10, wherein the paired process parameter is a fan power.

12. The process of claim 10, wherein the paired process parameter is an ideal velocity of a print head.

13. A system for printing a 3D object, comprising:
a print head carried by an x-y carriage, including a heated nozzle and a feed motor; and
a processor control system, wherein the processor control system includes executable code to:
parse computer numerical control code for printing a 3D object into a plurality of chunks, wherein the 3D object is printed with the print head;
determine a process value for each of the plurality of chunks;
select a scaling factor; and
adjust a paired process parameter in the computer numerical control code for each of the plurality of chunks based on the scaling factor.

14. The system of claim 13, wherein the processor control system further includes executable code to: compare the process value to an ideal value to determine the scaling factor, wherein the plurality of chunks is defined by a time period, the process value is an average velocity of the print head in a given direction and the ideal value is an ideal velocity of the print head in the given direction.

15. The system of claim 14, wherein the paired process parameter is a nozzle temperature of the heated nozzle.

16. The system of claim 14, wherein the processor control system further includes executable code to: compare the process value to an ideal value to determine a deviation, wherein the plurality of chunks define a geometry of a 3D printed object, the process value is an average velocity of the print head and the ideal value is an ideal velocity of the print head.

17. The system of claim 14, wherein the paired process parameter is a feed motor power supplied to the feed motor.

18. The system of claim 13, wherein the plurality of chunks is defined by a number of segments and the process value is a proximity metric defined by a displacement from an origin per the number of segments.

19. The system of claim 18, wherein the system further comprises a fan and the paired process parameter is a fan power supplied to the fan.

20. The system of claim 18, wherein the paired process parameter is a velocity of the print head.
